(19) United States
(12) Patent Application Publication
(10) Pub. No.: US 2022/0127107 A1
(43) Pub. Date: Apr. 28, 2022

(54) METHOD AND ELEVATOR ARRANGEMENT

(71) Applicant: Kone Corporation, Helsinki (FI)

(72) Inventors: Markku HAAPANIEMI, Helsinki (FI); Matti RASANEN, Helsinki (FI); Sami SAARELA, Helsinki (FI); Anssi VENHO, Helsinki (FI); Janne MIKKONEN, Helsinki (FI); Otto LANZ, Helsinki (FI); Tarvo VIITA-AHO, Helsinki (FI); Petri KERE, Helsinki (FI)

(73) Assignee: Kone Corporation, Helsinki (FI)

(21) Appl. No.: 17/569,053

(22) Filed: Jan. 5, 2022

Related U.S. Application Data
(63) Continuation of application No. PCT/EP2020/069545, filed on Jul. 10, 2020.

(30) Foreign Application Priority Data
Jul. 12, 2019 (EP) 19186070.9

(51) Int. Cl. B66B 1/24; B66B 7/06; B66B 9/00

(52) U.S. Cl. CPC B66B 1/2458; B66B 9/00; B66B 7/066; B66B 7/062

(57) ABSTRACT

The invention relates to a method for managing flow of people and goods within a building under construction, comprising providing one or more elevator control systems for automatically controlling movement of elevator cars; providing a first passenger elevator, the first passenger elevator comprising a first passenger elevator car for transporting people, the first passenger elevator car being vertically movable in an elevator hoistway formed inside the building under construction, vertical movement of the car being automatically controlled by an elevator control system, the first passenger elevator car comprising an interior delimited by floor, walls, ceiling and at least one automatic door; and providing a goods elevator, the goods elevator comprising a goods elevator car for transporting goods, the goods elevator car being vertically movable beside the first passenger elevator car in an elevator hoistway formed inside the building under construction, vertical movement of the goods elevator car being automatically controlled by an elevator control system, the goods elevator car comprising at least a transport platform; using the first passenger elevator to transport passengers between floors of the building under construction; and using the goods elevator to transport goods between floors of the building under construction. The invention also relates to an arrangement for managing flow of people and goods within a building under construction, which arrangement implements the method.

### CROSS-REFERENCE TO RELATED APPLICATION

This application is a continuation of PCT International Application No. PCT/EP2020/069545 which has an International filing date of Jul. 10, 2020, and which claims priority to European patent application number 19186070.9 filed Jul. 12, 2019, the entire contents of both of which are incorporated herein by reference.

### FIELD OF THE INVENTION

The invention relates a method and an elevator arrangement for managing flow of people and goods within a building under construction.

### BACKGROUND OF THE INVENTION

During construction work of a building, people and goods need to move for enabling construction work. For example, people need to move to the floor where their construction site is located, as well as away from that floor. Likewise, goods, such as tools, equipment and construction material need to move to the floor where the construction site of the respective tools, equipment and construction material is located.

In prior art, transportation of goods has been performed by lifting with a building crane and/or by a temporary elevator installed outside the building under construction. In prior art transportation of people has been performed by aid of a temporary elevator installed outside the building under construction or a construction-time elevator installed inside the building, such as a so-called jump elevator. A drawback in use of said known solutions has been that they have not been efficient and optimized in terms of flow and management of both people and goods, nor ensured smooth transition to serving transportation needs of the final building.

### BRIEF DESCRIPTION OF THE INVENTION

The object of the invention is to introduce a new method and a new elevator arrangement for managing flow of people and goods within a building under construction, which are efficient and optimized in terms of flow and management of both people and goods, at the same time ensuring smooth transition to serving transportation needs of the final building.

An object is to introduce a solution by which one or more of the above defined problems of prior art and/or problems discussed or implied elsewhere in the description can be solved. An object is particularly to introduce a solution which provides efficient and safe flow of people and goods during construction time of a building, and which enables simple and quick transition to serving needs of the final building, which may be different from those of the building during construction time thereof.

It is brought forward a new method for managing flow of people and goods within a building under construction, comprising providing one or more elevator control systems for automatically controlling movement of elevator cars; providing a first passenger elevator, the first passenger elevator comprising a first passenger elevator car for transporting people, the first passenger elevator car being vertically movable in an elevator hoistway formed inside the building under construction, vertical movement of the car being automatically controlled by an elevator control system, the first passenger elevator car comprising an interior delimited by floor, walls, ceiling and at least one automatic door; and providing a goods elevator, the goods elevator comprising a goods elevator car for transporting goods, the goods elevator car being vertically movable beside the first passenger elevator car in an elevator hoistway formed inside the building under construction, vertical movement of the goods elevator car being automatically controlled by an elevator control system, the goods elevator car comprising at least a transport platform; using the first passenger elevator to transport passengers between floors of the building under construction; and using the goods elevator to transport goods between floors of the building under construction. With this solution one or more of the above mentioned objects can be achieved.

Preferable further details are introduced in the following, which further details can be combined with the method individually or in any combination.

In a preferred embodiment, the method comprises subsequent to using the passenger elevator and the goods elevator a period of time, constructing a second passenger elevator in place of the goods elevator. Said constructing preferably comprises constructing a second passenger elevator car for transporting people in place of the goods elevator car, wherein the second passenger elevator car is vertically movable beside the first passenger elevator car in an elevator hoistway, vertical movement of the second passenger elevator car being controllable by an elevator control system, and in the constructing a second passenger elevator car the second passenger elevator car is made to comprise an interior delimited by floor, walls, ceiling and at least one automatic door; and thereafter using both the first and second passenger elevator to transport passengers between floors of the building.

In a preferred embodiment, vertical movement of the second passenger elevator car is controllable by the same elevator control system as vertical movement of the first passenger elevator car.

In a preferred embodiment, said using the first passenger elevator comprises receiving by an elevator control system first signals associated with the first passenger elevator; and said using the goods elevator comprises receiving by an elevator control system second signals associated with the goods elevator; and said using the first passenger elevator comprises automatically controlling by an elevator control system vertical movement of the first passenger elevator car only in response to the first signals of said first and second signals, and said using the goods elevator comprises automatically controlling by the elevator control system vertical movement of the goods elevator car only in response to the second signals of said first and second signals.

In a preferred embodiment, said using both the first and second passenger elevator comprises receiving by the same elevator control system signals associated with both of the first and second passenger elevator; and automatically controlling by the same elevator control system vertical movement of the first and second passenger elevator car in response to the signals associated with both of the first and second passenger elevator.

In a preferred embodiment, the first passenger elevator car is vertically movable along one or more vertically oriented guide rail lines in an elevator hoistway.

In a preferred embodiment, the goods elevator car is vertically movable along one or more vertically oriented guide rail lines in an elevator hoistway.

In a preferred embodiment, in said constructing a second passenger elevator car in place of the goods elevator car, the second passenger elevator car is arranged to be vertically movable along one or more of the vertically oriented guide rail lines of the goods elevator car. Thus, transformation of the goods elevator to form a second passenger elevator in its place is performed utilizing components of the goods elevator, which facilitates swiftness and economy of the transformation

In a preferred embodiment, one or more components comprised in the goods elevator car, such as one or more of a car frame, guide members, such as roller guides or slide guides, a transport platform, are utilized in the constructing a second passenger elevator car in place of the goods elevator car. In this case, preferably said constructing a second passenger elevator car in place of the goods elevator car is performed such that one or more of a car frame, guide members, such as roller guides or slide guides, a transport platform form corresponding part(s) of the second passenger elevator car. Thus, transformation of the goods elevator to form a second passenger elevator in its place is performed utilizing components of the goods elevator, which facilitates swiftness and economy of the transformation.

In a preferred embodiment, the method comprises shifting the using of the first passenger elevator on one or more temporary pauses during which the traveling zone of the car of the first passenger elevator is extended to reach higher and after which the using is continued.

In a preferred embodiment, the method comprises shifting the using of the goods elevator on one or more temporary pauses during which the traveling zone of the car of the goods elevator is extended to reach higher and after which the using is continued.

In a preferred embodiment, the first and second signals are received from different signal sources.

In a preferred embodiment, the first signals are received from a first signal equipment, and the second signals are received from a second signal equipment.

In a preferred embodiment, the method comprises moving a load on to and/or from the goods elevator car using a loading device preferably mounted on top of a floor of the building under construction in front of an opening leading to the hoistway in which the goods elevator car is movable.

In a preferred embodiment, the method comprises moving a load on to and/or from the goods elevator car using a loading device preferably mounted on top of a transport platform of the goods elevator car.

In a preferred embodiment, the loading device comprises a conveying track on top of which the load can be moved supported by the conveying track, the conveying track comprising one or more rotatable elements, such as one or more rotatable rollers or one or more rotatable belts or one or more rotatable chains on top of which the load can be moved supported by the one or more rotatable elements.

It is also brought forward a new arrangement for managing flow of people and goods within a building under construction, comprising one or more elevator control systems for automatically controlling movement of elevator cars; at least two hoistways formed in a building under construction; a first passenger elevator comprising a first passenger elevator car for transporting people, the first passenger elevator car being vertically movable in an elevator hoistway formed inside the building under construction, vertical movement of the first passenger elevator car being automatically controlled by an elevator control system, the first passenger elevator car comprising an interior delimited by floor, walls, ceiling and at least one automatic door; and a goods elevator comprising a goods elevator car for transporting goods, the goods elevator car being vertically movable beside the passenger elevator car (5) in an elevator hoistway formed inside the building under construction, vertical movement of the goods elevator car being automatically controlled by an elevator control system, the goods elevator car comprising at least a transport platform. With this solution one or more of the above mentioned objects can be achieved. Preferable further details have been introduced earlier above as well as in the following, which further details can be combined with the arrangement individually or in any combination.

In a preferred embodiment, the control system controlling vertical movement of the first passenger elevator car, is configured to receive first signals associated with the first passenger elevator for enabling using the first passenger elevator to transport passengers between floors of the building under construction, and to control vertical movement of the passenger elevator car only in response to the first signals of said first and second signals; and the control system controlling vertical movement of the goods elevator car (3), is configured to receive second signals associated with the goods elevator for enabling using the goods elevator to transport goods between floors of the building under construction, and to control vertical movement of the goods elevator car only in response to the second signals of said first and second signals.

In a preferred embodiment, the goods elevator car does not comprise a door.

In a preferred embodiment, the goods elevator car does not comprise an automatic door, in particular a door opening and closing movement of which is automatically controlled by an elevator control system.

In a preferred embodiment, the goods elevator car does not comprise an interior delimited by floor, walls, ceiling and an automatic door, in particular a door opening and closing movement of which is automatically controlled by an elevator control system.

In a preferred embodiment, the goods elevator car is vertically movable along one or more vertically oriented guide rail lines in an elevator hoistway.

In a preferred embodiment, the arrangement comprises a first signal equipment for sending first signals to a control system and a second signal equipment for sending second signals to a control system. Preferably, separation of signaling is facilitated such that the first signal equipment cannot send the second signals, and the second signal equipment cannot send the first signals.

In a preferred embodiment, the first signal equipment comprises a user interface operable by a user, such as a user interface comprising a touch screen or buttons. The first signal equipment can comprise for instance a portable communication device, such as a mobile phone or a tablet, comprising said user interface operable by a user.

In a preferred embodiment, the first signal equipment are arranged to receive a selection input by the user. Preferably, it is arranged to generate a first signal based on the selection.

In a preferred embodiment, the second signal equipment comprises a reader for reading an identification provided on a load to be transported by the goods elevator, such as on a transport container. The second signal equipment is preferably moreover arranged to generate a second signal based on the identification. The reader can be for instance a rfid reader in which case the identification is preferably an rfid-tag.

In a preferred embodiment, the arrangement comprises a loading device for facilitating moving a load on to and/or from the goods elevator car, which loading device is preferably mounted on top of a floor of the building under construction in front of an opening leading to the hoistway in which the goods elevator car is movable.

In a preferred embodiment, the arrangement comprises a loading device for facilitating moving a load on to and/or from the goods elevator car, which loading device is preferably mounted on top of a transport platform of the goods elevator car.

In a preferred embodiment, the loading device comprises a conveying track on top of which the load can be moved supported by the conveying track, the conveying track comprising one or more rotatable elements, such as one or more rotatable rollers or one or more rotatable belts or one or more rotatable chains on top of which the load can be moved supported by the one or more rotatable elements.

In a preferred embodiment, the vertical movement ranges of the first passenger elevator car and the goods elevator car at least partially overlap (i.e. when viewed in horizontal direction), but most preferably they are the same, or at least substantially the same.

In a preferred embodiment, the first and second hoistway are beside each other such that their heights at least partially overlap (i.e. when viewed in horizontal direction). Thus, they can be used to transport passenger and goods to same floors of the building under construction. Most preferably, their heights overlap completely as presented, or at least substantially completely, meaning that at least 80 percent of their heights overlap.

In a preferred embodiment, the first and second hoistway are separated by a concrete wall extending between them. However, it is not necessary to separate said hoistways by a structure between them, since the space between them could alternatively be empty. Also, alternatively the separation could be provided by a other structures that concrete wall, such as beams extending between the first and second hoistway.

In a preferred embodiment, the building under construction is preferably such that it has not reached its final height yet, the upper parts thereof still being missing. Hereby, preferably during the method, the building under construction is constructed to be higher, most preferably during the method new floors are constructed on existing floors of the building under construction.

In a preferred embodiment, each said elevator hoistway is a space inside the building under construction wherein an elevator car can move vertically.

In a preferred embodiment, each said elevator hoistway is delimited by one or more inner walls of the building, said walls preferably being concrete walls.

Each of the aforementioned elevators is preferably such that the car thereof is vertically movable to and from two or more floors, which are vertically displaced. Preferably, when a car is at a floor, the sill thereof is level with a sill of the floor in question.

### BRIEF DESCRIPTION OF THE DRAWINGS

In the following, the present invention will be described in more detail by way of example and with reference to the attached drawings, in which

FIG. 1 illustrates an embodiment of an arrangement according to the invention for managing flow of people and goods within a building under construction provided with a method according to the invention.

FIG. 2 illustrates the arrangement of FIG. 1 in a later phase of the method according to the invention.

FIG. 3 illustrates a first alternative of preferred details of the arrangement of FIG. 1.

FIG. 4 illustrates a second alternative of preferred details of the arrangement of FIG. 1.

FIG. 5 illustrates preferred details of the arrangement of FIG. 2.

FIG. 6 illustrates preferred details of the arrangement of FIG. 1 as well as of the method.

FIG. 7 illustrates preferred details of the arrangement of FIG. 6.

### DETAILED DESCRIPTION

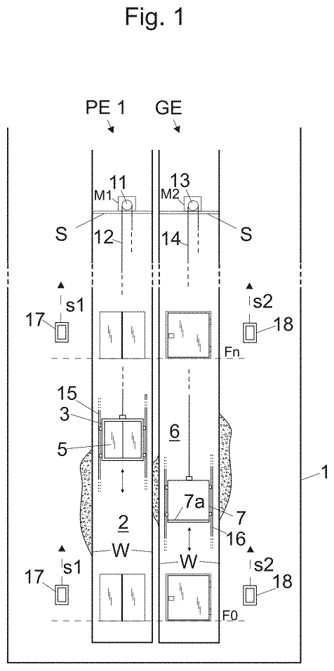

FIG. 1 illustrates an arrangement as provided at a phase of a method for managing flow of people and goods within a building 1 under construction.

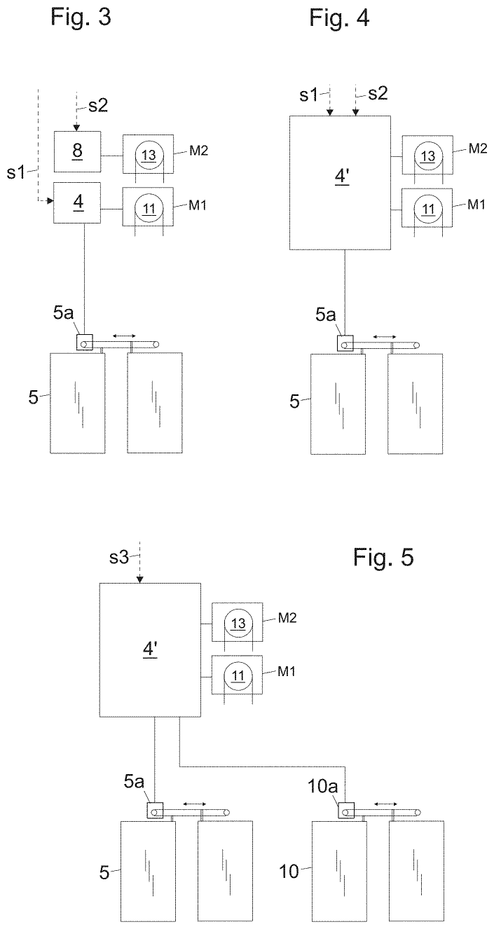

The method comprises providing one or more elevator control systems 4,8;4′ for automatically controlling movement of elevator cars. The one or more elevator control systems 4,8;4′ can be for example as later described referring to FIG. 3 or 4.

The method further comprises providing a first passenger elevator PE1 as presented in FIG. 1, the first passenger elevator El comprising a first passenger elevator car 3 for transporting people, the first passenger elevator car 3 being vertically movable in an elevator hoistway 2 (also referred to as the first hoistway) formed inside the building 1 under construction. Vertical movement of the car 3 is controlled in the method by an elevator control system 4;4′. The first passenger elevator car 3 comprises an interior delimited by floor, walls, ceiling and at least one automatic door 5. The door 5 being an automatic door makes the car 3 well suitable for safely serving of passengers, in particular for ensuring closing and opening doorway of the elevator car 3. Opening and closing movement of the automatic door 5 is preferably controllable by the aforementioned elevator control system 4;4′ controlling the vertical movement of the first passenger elevator car 3.

The method further comprises providing a goods elevator GE as presented in FIG. 1, the goods elevator comprising a goods elevator car 7 for transporting goods, the goods elevator car 7 being vertically movable beside the passenger elevator car 5 in an elevator hoistway 6 (also referred to as the second hoistway) formed inside the building 1 under construction. Preferably, the vertical movement ranges of the first passenger elevator car 3 and the goods elevator car 7 at least partially overlap (i.e. when viewed in horizontal direction), but most preferably they are the same as presented, or at least substantially the same. Vertical movement of the goods elevator car 7 is automatically controlled by an elevator control system 8;4′. The goods elevator car 7 preferably comprises at least a transport platform 7a. This may be sufficient since it does not need to fulfil requirements set for a passenger elevator. For example, it does not need to have a door, which enables efficient loading of heavy and large goods thereon, e.g. large transport containers.

The method further comprises using the first passenger elevator PE1 to transport passengers between floors F0,Fn of the building 1 under construction and using the goods elevator GE to transport goods between floors F0-Fn of the building 1 under construction. An advantage is that the efficiency of flow of people and goods is efficient and safe already during construction of the building 1. Requirements of passenger transport and goods transport being different, these operations can hereby be separated and optimized such that small amount of changes will be required in a later transition to serving needs of the final building.

In the preferred embodiment of FIG. 1, the first and second hoistway 2,6 are beside each other such that their heights at least partially overlap (i.e. when viewed in horizontal direction). Thus, they can be used to transport passenger and goods to same floors F0,Fn of the building under construction 1. Most preferably, their heights overlap completely as presented, or at least substantially completely, meaning that at least 80 percent of their heights overlap.

In the preferred embodiment of FIG. 1, the first and second hoistway 2,6 are separated by a concrete wall extending between them. However, it is not necessary to separate said hoistways by a structure between them, since the space between them could alternatively be empty. Also, alternatively the separation could be provided by a other structures that concrete wall, such as beams extending between the first and second hoistway 2,6.

The building 1 under construction is preferably such that it has not reached its final height yet, the upper parts thereof still being missing. Hereby, preferably during the method, the building 1 under construction is constructed to be higher, most preferably during the method new floors are constructed on existing floors of the building 1 under construction.

In the preferred embodiment of FIG. 1, each said elevator hoistway 2, 6 is a space inside the building under construction 1 wherein an elevator car can move vertically.

In the preferred embodiment of FIG. 1, each said elevator hoistway 2, 6 is delimited by one or more inner walls W of the building 1, said walls W preferably being concrete walls.

The first passenger elevator car 3 is preferably vertically movable along one or more vertically oriented guide rail lines 15 in the elevator hoistway 2. Likewise, preferably the goods elevator car 7 is vertically movable along one or more vertically oriented guide rail lines 16 in an elevator hoistway 6.

In said using the first passenger elevator PE1 to transport passengers between floors of the building under construction; and said using the goods elevator to transport goods between floors (F0-Fn) of the building under construction 1, the first passenger elevator car 3 is preferably moved by a first motor M1 arranged to move a first roping 12 connected with the first passenger elevator car 3. Correspondingly, the goods elevator car 7 is preferably moved by a second motor M2 arranged to move a second roping 14 connected with the goods elevator car 7. The motors M1 and M2 can be arranged to engage the first and second roping 12, 14, respectively, via a drive sheave 11,13.

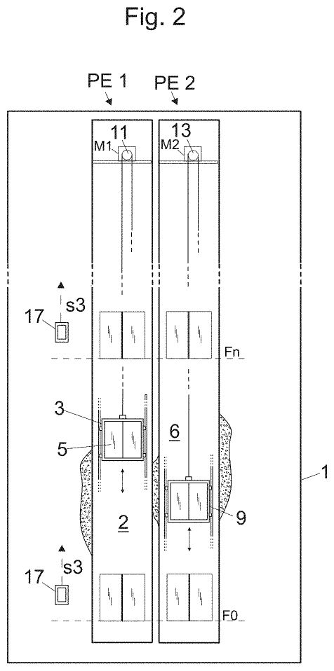

FIG. 2 illustrates an arrangement as provided at a phase of the method, which phase follows the phase illustrated in FIG. 1.

The method comprises, subsequent to using the first passenger elevator PE1 and the goods elevator GE a period of time, constructing a second passenger elevator PE2 in place of the goods elevator GE, as presented in FIG. 2. Said constructing comprises constructing a second passenger elevator car 9 for transporting people in place of the goods elevator car 7, wherein the second passenger elevator car 9 is vertically movable beside the first passenger elevator car 3 in an elevator hoistway 6, i.e. the second elevator hoistway, vertical movement of the second passenger elevator car 9 being controllable by an elevator control system 4′, and in which constructing a second passenger elevator car 9 the second passenger elevator car 9 is made to comprise an interior delimited by floor, walls, ceiling and at least one automatic door 10; and thereafter using both the first and second passenger elevator to transport passengers between floors F0-Fn of the building 1.

The door 10 being an automatic door makes the car 9 well suitable for safely serving of passengers, in particular for ensuring closing and opening doorway of the elevator car 9. Opening and closing movement of said automatic door 10 is preferably automatically controlled by the aforementioned elevator control system 4′ controlling the vertical movement of the second passenger elevator car 9.

In said constructing a second passenger elevator car 9 in place of the goods elevator car 7, the second passenger elevator car 9 is preferably arranged to be vertically movable along one or more of the vertically oriented guide rail lines 16 of the goods elevator car 7. Thus, transformation of the goods elevator GE to form a second passenger elevator PE2 in its place is performed utilizing the hoistway 6 as well as components of the goods elevator GE.

Likewise, it is preferred that said constructing a second passenger elevator car 9 in place of the goods elevator car 7 is performed such that one or more of a car frame 24, guide members 25, such as roller guides or slide guides and a transport platform 7a form(s) corresponding part(s) of the second passenger elevator car 9.

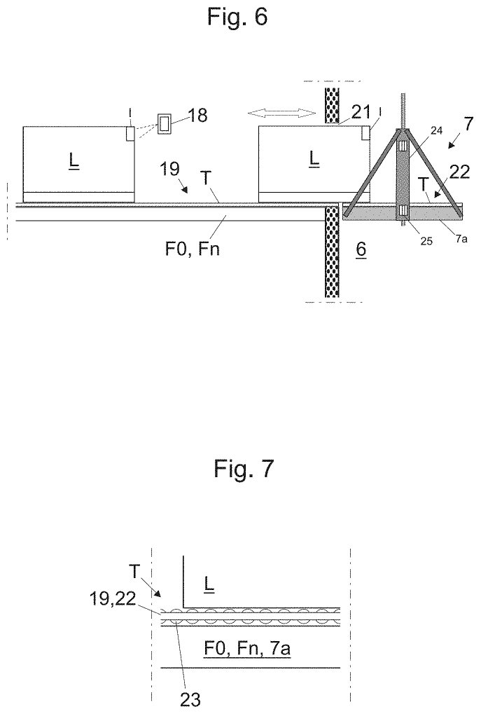

Thus, transformation of the goods GE elevator to form a second passenger elevator PE2 in its place is performed utilizing components of the goods elevator GE, which facilitates swiftness and economy of the transformation. Some of the referred features are optional and illustrated in FIG. 6.

FIG. 3 illustrates optional details for the solution presented in FIG. 1, according to a first preferred alternative, for controlling vertical movement of the first passenger elevator car 3 and the goods elevator car 7, as well as movement of the automatic door 5 of the first passenger elevator car 3. In this embodiment, vertical movement of the first passenger elevator car 3 and vertical movement of the goods elevator car 7 are automatically controlled by different elevator control systems 4 and 8, respectively. FIG. 3 also illustrates the door machinery 5a for moving the automatic door 5 of the first passenger elevator car 3.

In the embodiment of FIG. 3, said using the first passenger elevator PE1 comprises receiving by an elevator control system 4 first signals s1 associated with the first passenger elevator; and said using the goods elevator GE comprises receiving by an elevator control system 8 second signals s2 associated with the goods elevator; and said using the first passenger elevator PE1 comprises automatically controlling by the elevator control system 4 vertical movement of the first passenger elevator car 3 only in response to the first signals s1 of said first and second signals s1, s2, and said using the goods elevator GE comprises automatically controlling by the elevator control system 8 vertical movement of the goods elevator car 7 only in response to the second signals s2 of said first and second signals s1, s2.

FIG. 4 illustrates optional details for the solution presented in FIG. 1, according to a preferred second alternative, for controlling vertical movement of the first passenger elevator car 3 and the goods elevator car 7, as well as movement of the automatic door 5 of the first passenger elevator car 3. In this embodiment, vertical movement of the first passenger elevator car 3 and vertical movement of the goods elevator car 7 are automatically controlled by the same elevator control systems 4′. FIG. 4 also illustrates the door machinery Sa for moving the automatic door S of the first passenger elevator car 3.

In the embodiment of FIG. 4, said using the first passenger elevator PE1 comprises receiving by an elevator control system 4′ first signals s1 associated with the first passenger elevator; and said using the goods elevator GE comprises receiving by an elevator control system 4′ second signals s2 associated with the goods elevator GE; and said using the first passenger elevator PE1 comprises automatically controlling by the elevator control system 4′ vertical movement of the first passenger elevator car 3 only in response to the first signals s1 of said first and second signals s1, s2, and said using the goods elevator GE comprises automatically controlling by the elevator control system 4′ vertical movement of the goods elevator car 7 only in response to the second signals s2 of said first and second signals s1, s2.

In the preferred embodiment of FIG. 4, the first and second signals s1, s2 are received from different signal sources 17, 18, as showed in FIG. 1. Hereby, at least during a period when the first passenger elevator is in use to transport passengers between floors of the building under construction and the goods elevator is in use to transport goods between floors F0-Fn of the building under construction, the first and second signals s1, s2 are received from different signal equipment. This is advantageous, since it facilitates simplicity of the arrangement for calling a specific elevator in the building under construction 1, and special requirements of these different elevators can be simply met, e.g. with regard to positioning of components. For instance, many of the requirements of the goods elevator GE may be temporary. Hereby, the configuration of the devices for calling the goods elevator GE can be simply made temporary to be later modified. Hereby, for instance route of the goods to the goods elevator can be taken into account. The devices of the passenger elevator need not be dangerously close to the route of the goods to the goods elevator GE. Also, the signal equipment can be different and/or operate differently. Signaling is implemented in FIG. 1 such that the first signals s1 are received from a first signal equipment 17, and the second signals s2 are received from a second signal equipment 18. Preferably, separation of signaling is facilitated further such that the first signal equipment cannot send the second signals s2, and the second signal equipment 18 cannot send the first signals s1. Although advantageous as described above, it is not necessary that the first and second signals s1, s2 are received from different signal sources 17, 18. One or more of the objects of the invention can be achieved despite the details of the signals, such as what kind of signals, and how and from where signals are received.

Generally, the first and second signal equipment 17,18 can be of any known kind. However, preferably, the first signal equipment 17 comprises a user interface operable by a user, such as a user interface comprising a touch screen or buttons. The first signal equipment 17 are preferably arranged to receive a selection input by the user. The first signal equipment 17 can comprise for instance a portable communication device, such as a mobile phone or a tablet, comprising said user interface operable by a user. Likewise, the second signal equipment 18 can comprise for instance a portable communication device, such as a mobile phone or a tablet, comprising said user interface operable by a user.

In general, it is preferable, although not necessary, that the signal equipment 17 and/or 18 comprises at least a user interface mounted immovably on the building 1 under construction. Thus it can be accessed and operated at a certain location near the elevator PE1,GE.

FIG. 5 illustrates optional details of FIG. 2, according to a preferred alternative, for controlling vertical movement of the first passenger elevator car 3 and the second passenger elevator car 9, as well as movement of the automatic door 5 of the first passenger elevator car 3 and movement of the automatic door 10 of the second passenger elevator car 10. In this embodiment, vertical movement of the second passenger elevator car 9 is controllable by the same elevator control system 4′ as vertical movement of the first passenger elevator car 3. Should the control have been earlier arranged in accordance to FIG. 3, the method may necessitate modifying the control systems. Should the control have been earlier arranged in accordance to FIG. 4, the method may not necessitate modifying the control system 4′.

In the embodiment of FIG. 5, said using both the first and second passenger elevator comprises receiving by the same elevator control system 4′ signals s3 associated with both of the first and second passenger elevator; and automatically controlling by the same elevator control system 4′ vertical movement of the first and second passenger elevator car 7, 9 in response to the signals s3 associated with both of the first and second passenger elevator. Thus, the same elevator control system 4′ decides can choose to move either one of the first and second passenger elevator PEI, PE2 in response to receiving a signal s3. Responding to a signal s3 by either one of the elevators is advantageous in this way is advantageous since they are both passenger elevators and a more sophisticated optimization is achievable when the same elevator control system 4′ can choose the best available elevator for responding to a signal from plurality of elevators. Of course, alternatively the first and second passenger elevator PE1, PE2 could be served in response to signals from different sources.

The traveling zone of the first passenger elevator PE1 and/or the goods elevator GE can be extended to reach higher during the method. Then, preferably the method comprises shifting the using of the first passenger elevator PE1 on one or more temporary pauses during each of which the traveling zone of the car 3 of the first passenger elevator PE is extended to reach higher and after which the using is continued. Likewise, preferably the method comprises shifting the using of the goods elevator on one or more temporary pauses during each of which the traveling zone of the car 7 of the goods elevator GE is extended to reach higher and after which the using is continued. Such extension is preferable when the height of the building 1 under construction rises during the method. If and when the traveling zone of one or both of the elevators PE1, GE is extended, it is preferable to utilize technology of so called ‘jump elevators’, for example. Then it is preferable to utilize in the method a movable support structure S for supporting the car 3,7 of the elevator PE1, GE in question, which support structure S is mounted in the hoistway 2,6 of the elevator PE1, GE in question such that can be lifted to a higher position in the hoistway 2,6. Additional length of roping 12,14 of the elevator PE1, GE in question is preferably also stored in a rope supply storage (not showed), such as one or more rope reels, wherefrom it can be supplied via a releasable rope clamp (not showed). There are also other kind of elevators the traveling height of which can be extended, where one or more of the above described features of a ‘jump elevator’ may be unnecessary due to different type of solution.

FIGS. 6 and 7 illustrate preferred, although optional, details of the goods elevator GE and the method. As illustrated, the method preferably, although not necessarily, comprises moving a load on to and/or from the goods elevator car 7 using a loading device 19 mounted on top of a floor F0,Fn of the building 1 under construction in front of an opening 21 leading to the hoistway 6 in which the goods elevator car 7 is movable and/or using a loading device 22 mounted on top of a transport platform 7a of the goods elevator car 7. Thus, efficiency of the goods elevator GE specialized for goods transport can be further facilitated. Particularly, loading of heavy objects, such as transport containers, is facilitated to the extent that transport becomes quick, safe and simple to make at least partially automatic.

Preferably, this is implemented such that the loading device 19;22 comprises a conveying track T on top of which the load L can be moved supported by the conveying track T, the conveying track T comprising one or more rotatable elements 23, such as one or more rotatable rollers, as showed in FIG. 7, or alternatively one or more rotatable belts or one or more rotatable chains on top of which the load can be moved supported by the one or more rotatable elements.

An embodiment of an arrangement according to the invention for managing flow of people and goods within a building 1 under construction is illustrated and earlier described referring to FIG. 1. The arrangement facilitates performing the method described above. The arrangement according to the invention comprises one or more elevator control systems 4,8;4′ for automatically controlling movement of elevator cars 3,7, and a first passenger elevator comprising a first passenger elevator car 3 for transporting people, the first passenger elevator car 3 being vertically movable in an elevator hoistway 2 formed inside the building 1 under construction, vertical movement of the first passenger elevator car 3 being automatically controlled by an elevator control system 4;4′, the first passenger elevator car 3 comprising an interior delimited by floor, walls, ceiling and at least one automatic door; and a goods elevator comprising a goods elevator car 7 for transporting goods, the goods elevator car 7 being vertically movable beside the passenger elevator car 5 in an elevator hoistway 6 formed inside the building 1 under construction, vertical movement of the goods elevator car 7 being automatically controlled by an elevator control system 4′;8, the goods elevator car 7 comprising at least a transport platform 7a.

FIGS. 3 and 4 illustrate alternative configurations with optional details for the solution presented in FIG. 1, as already described above. Preferably, the control system (4 in FIG. 3; 4′ in FIG. 4) controlling vertical movement of the first passenger elevator car 3 is configured to receive first signals s1 associated with the first passenger elevator PE1 for enabling using the first passenger elevator PE1 to transport passengers between floors of the building 1 under construction, and to control vertical movement of the passenger elevator car 3 only in response to the first signals s1 of said first and second signals s1,s2; and the control system (8 in FIG. 3; 4′ in FIG. 4) controlling vertical movement of the goods elevator car 3, is configured to receive second signals s2 associated with the goods elevator for enabling using the goods elevator GE to transport goods between floors of the building 1 under construction, and to control vertical movement of the goods elevator car 6 only in response to the second signals s2 of said first and second signals s1,s2.

In general, the goods elevator car 3 is preferably made very simple and optimized for goods transport in a building under construction 1 without fulfilling requirements of a passenger elevator car, namely requirements of passenger elevator safety codes. Also many common requirements of an end user of a passenger elevator need not met. In the preferred embodiments presented, the goods elevator car 3 is made simple and it does not comprise an interior delimited by floor, walls, ceiling and an automatic door. One or more lateral sides of the goods elevator car can thus be open and/or the upper side of the goods elevator car can thus is open. In general, it is preferable that the goods elevator car 3 does not comprise an automatic door, e.g. one opening and closing movement of which is automatically controlled by an elevator control system. Actually, it is even more preferable that the goods elevator car 3 does not comprise a door at all, since hereby loading of the goods elevator car 3 is quick and efficient. Of course, a landing door can be used nevertheless for blocking access to the hoistway 6 when the goods elevator car 3 is absent from the floor in question.

The arrangement comprises a first signal equipment 17 for sending first signals s1 to a control system 4;4′ and a second signal equipment 18 for sending second signals s1 to a control system 8;4′. Preferably, separation of signaling is facilitated such that the first signal equipment 17 cannot send the second signals (s2), and the second signal equipment 18 cannot send the first signals s1.

Generally, the first and second signal equipment 17,18 can be of any known kind. However, preferably, the first signal equipment 17 comprises a user interface operable by a user, such as a user interface comprising a touch screen or buttons. The first signal equipment 17 are preferably arranged to receive a selection input by the user. The first signal equipment 17 can comprise for instance a portable communication device, such as a mobile phone or a tablet, comprising said user interface operable by a user. Likewise, the second signal equipment 18 can comprise for instance a portable communication device, such as a mobile phone or a tablet, comprising said user interface operable by a user.

Referring to FIG. 6, the second signal equipment 18 preferably, although not necessarily, comprise a reader for reading an identification I provided on a load L to be transported, such as a transport container, by the goods elevator GE. The second signal equipment 18 is preferably moreover arranged to generate a second signal s2 based on the identification.

Referring to FIGS. 6 and 7, the arrangement preferably, although not necessarily, comprises a loading device 19 for facilitating moving a load on to and/or from the goods elevator car 7, which loading device 19 is mounted on top of a floor F0,Fn of the building 1 under construction in front of an opening 21 leading to the hoistway 6 in which the goods elevator car 7 is movable.

Referring to FIGS. 6 and 7, the arrangement preferably, although not necessarily, comprises a loading device 22 for facilitating moving a load on to and/or from the goods elevator car 7, which loading device 22 is mounted on top of a transport platform 7a of the goods elevator car 7.

Preferably, the loading device 19 and/or 22 comprises a conveying track T on top of which the load L can be moved supported by the conveying track, the conveying track comprising one or more rotatable elements 23, such as one or more rotatable rollers or one or more rotatable belts or one or more rotatable chains on top of which the load can be moved supported by the one or more rotatable elements.

In general, it is preferable that each aforementioned automatic door 5,10 is such that opening and closing movement of an automatic door is automatically controlled by the elevator control system automatically controlling the vertical movement of the passenger elevator car 3,9 comprising said automatic door 5,10.

In general, it is preferable to utilize some of the components of the goods GE elevator in the constructing a second passenger elevator PE2 in place of the goods elevator GE, since this facilitates swiftness and economy of the transformation. Earlier above some components have been mentioned. Preferably, additionally or alternatively, one or more of the counterweight (not showed in Figures), the counterweight guide rails (not showed in Figures), the motor M2, and the drive sheave 13 comprised in the goods elevator GE are utilized in the constructing a second passenger elevator PE2 in place of the goods elevator GE.

As mentioned, the conveying track T may comprise one or more rotatable rollers, for instance. In this case, the rollers preferably comprise a line of rollers 23 with parallel rotational axes so that a load L can be moved supported by the conveying track T linearly. Also, a more sophisticated implementation of a conveying track can be used, where omnidirectional movement on the conveying track can be achieved, for example using a conveying track comprising so called omni-directional movement modules such as known from a commercially available Omnidirectional Cellular Conveyor, for example.

It is to be understood that the above description and the accompanying Figures are only intended to teach the best way known to the inventors to make and use the invention. It will be apparent to a person skilled in the art that the inventive concept can be implemented in various ways. The above-described embodiments of the invention may thus be modified or varied, without departing from the invention, as appreciated by those skilled in the art in light of the above teachings. It is therefore to be understood that the invention and its embodiments are not limited to the examples described above but may vary within the scope of the claims.

1. A method for managing flow of people and goods within a building under construction, comprising
providing one or more elevator control systems for automatically controlling movement of elevator cars;
providing a first passenger elevator, the first passenger elevator comprising a first passenger elevator car for transporting people, the first passenger elevator car being vertically movable in an elevator hoistway formed inside the building under construction, vertical movement of the car being automatically controlled by an elevator control system, the first passenger elevator car comprising an interior delimited by floor, walls, ceiling and at least one automatic door; and
providing a goods elevator, the goods elevator comprising a goods elevator car for transporting goods, the goods elevator car being vertically movable beside the first passenger elevator car in an elevator hoistway formed inside the building under construction, vertical movement of the goods elevator car being automatically controlled by an elevator control system, the goods elevator car comprising at least a transport platform;
using the first passenger elevator to transport passengers between floors of the building under construction;
using the goods elevator to transport goods between floors of the building under construction.

2. A method according to claim 1, wherein the method comprises subsequent to using the passenger elevator and the goods elevator a period of time, constructing a second passenger elevator in place of the goods elevator, said constructing comprising constructing a second passenger elevator car for transporting people in place of the goods elevator car, wherein the second passenger elevator car is vertically movable beside the first passenger elevator car in an elevator hoistway, vertical movement of the second passenger elevator car being controllable by an elevator control system, and in which constructing a second passenger elevator car the second passenger elevator car is made to comprise an interior delimited by floor, walls, ceiling and at least one automatic door; and thereafter using both the first and second passenger elevator to transport passengers between floors of the building.

3. A method according to claim 1, wherein vertical movement of the second passenger elevator car is controllable by the same elevator control system as vertical movement of the first passenger elevator car.

4. A method according to claim 1, wherein
said using the first passenger elevator comprises receiving by an elevator control system first signals associated with the first passenger elevator; and
said using the goods elevator comprises receiving by an elevator control system second signals associated with the goods elevator; and
said using the first passenger elevator comprises automatically controlling by an elevator control system vertical movement of the first passenger elevator car only in response to the first signals of said first and second signals,
said using the goods elevator comprises automatically controlling by an elevator control system vertical movement of the goods elevator car only in response to the second signals of said first and second signals.

5. A method according to claim 1, wherein said using both the first and second passenger elevator comprises
receiving by the same elevator control system signals associated with both of the first and second passenger elevator; and
automatically controlling by the same elevator control system vertical movement of the first and second passenger elevator car in response to the signals associated with both of the first and second passenger elevator.

6. A method according to claim 1, wherein the first passenger elevator car is vertically movable along one or more vertically oriented guide rail lines in an elevator hoistway.

7. A method according to claim 1, wherein the goods elevator car is vertically movable along one or more vertically oriented guide rail lines in an elevator hoistway.

8. A method according to claim 1, wherein in said constructing, the second passenger elevator car is arranged to be vertically movable along one or more of the vertically oriented guide rail lines of the goods elevator car.

9. A method according to claim 1, wherein the method comprises shifting the using of the first passenger elevator on one or more temporary pauses during which the traveling zone of the car of the first passenger elevator is extended to reach higher and after which the using is continued.

10. A method according to claim 1, wherein the method comprises shifting the using of the goods elevator on one or more temporary pauses during which the traveling zone of the car of the goods elevator is extended to reach higher and after which the using is continued.

11. A method according to claim 1, wherein the first and second signals are received from different signal sources, preferably such that the first signals are received from a first signal equipment, and the second signals are received from a second signal equipment.

12. A method according to claim 1, wherein the method comprises moving a load onto and/or from the goods elevator car using a loading device mounted on top of a floor of the building under construction in front of an opening leading to the hoistway in which the goods elevator car is movable.

13. A method according to claim 1, wherein the method comprises moving a load onto and/or from the goods elevator car by aid of a loading device mounted on top of a transport platform of the goods elevator car.

14. A method according to claim 1, wherein the loading device comprises a conveying track on top of which the load can be moved supported by the conveying track, the conveying track comprising one or more rotatable elements, such as one or more rotatable rollers or one or more rotatable belts or one or more rotatable chains on top of which the load can be moved supported by the one or more rotatable elements.

15. An arrangement for managing flow of people and goods within a building under construction, comprising
one or more elevator control systems for automatically controlling movement of elevator cars;
a first passenger elevator comprising a first passenger elevator car for transporting people, the first passenger elevator car being vertically movable in an elevator hoistway formed inside the building under construction, vertical movement of the first passenger elevator car being automatically controlled by an elevator control system, the first passenger elevator car comprising an interior delimited by floor, walls, ceiling and at least one automatic door; and
a goods elevator comprising a goods elevator car for transporting goods, the goods elevator car being vertically movable beside the passenger elevator car in an elevator hoistway formed inside the building under construction, vertical movement of the goods elevator car being automatically controlled by an elevator control system, the goods elevator car comprising at least a transport platform.

16. An arrangement according to claim 15, wherein
the control system controlling vertical movement of the first passenger elevator car, is configured to receive first signals associated with the first passenger elevator for enabling using the first passenger elevator to transport passengers between floors of the building under construction, and to control vertical movement of the passenger elevator car only in response to the first signals of said first and second signals; and
the control system controlling vertical movement of the goods elevator car, is configured to receive second signals associated with the goods elevator for enabling using the goods elevator to transport goods between floors of the building under construction, and to control vertical movement of the goods elevator car only in response to the second signals of said first and second signals.

17. An arrangement according to claim 15, wherein the goods elevator car does not comprise an automatic door.

18. An arrangement according to claim 15, wherein the goods elevator car does not comprise an interior delimited by floor, walls, ceiling and an automatic door.

19. An arrangement according to claim 15, wherein the goods elevator car is vertically movable along one or more vertically oriented guide rail lines in an elevator hoistway.

20. An arrangement according to claim 15, wherein the arrangement comprises a first signal equipment for sending first signals to a control system and a second signal equipment for sending second signals to a control system.

21. An arrangement according to claim 15, wherein the second signal equipment comprises a reader for reading an identification provided on a load, such as a transport container, to be transported by the goods elevator.

22. An arrangement according to claim 15, wherein the arrangement comprises a loading device for facilitating moving a load on to and/or from the goods elevator car, which loading device is preferably mounted on top of a floor of the building under construction in front of an opening leading to the hoistway in which the goods elevator car is movable.

23. An arrangement according to claim 15, wherein the arrangement comprises a loading device for facilitating moving a load on to and/or from the goods elevator car, which loading device is preferably mounted on top of a transport platform of the goods elevator car.

24. An arrangement according to claim 15, wherein the loading device comprises a conveying track on top of which the load can be moved supported by the conveying track, the conveying track comprising one or more rotatable elements, such as one or more rotatable rollers or one or more rotatable belts or one or more rotatable chains on top of which the load can be moved supported by the one or more rotatable elements.
